(19) United States
(12) Patent Application Publication
(10) Pub. No.: US 2025/0198463 A1
(43) Pub. Date: Jun. 19, 2025

(54) BEARING

(71) Applicant: AKTIEBOLAGET SKF, GOTEBORG (SE)

(72) Inventors: Wei LI, Shanghai (CN); Jianying YANG, Kunshan (CN); Wei WANG, Shanghai (CN); Hongyuan AN, Shanghai (CN)

(21) Appl. No.: 18/975,530

(22) Filed: Dec. 10, 2024

(30) Foreign Application Priority Data
Dec. 18, 2023 (CN) 202311746783.3

(51) Int. Cl. F16C 33/66

(52) U.S. Cl. CPC F16C 33/6681

(57) ABSTRACT

A bearing includes an inner ring having an inner raceway, an outer ring having an outer raceway, rolling elements located between the inner raceway and the outer raceway, a cage for holding the rolling elements, and a seal. A bearing inner space is defined by the inner ring, the outer ring and the seal and a free space is a portion of the bearing inner space not occupied by the rolling elements and the cage. The lubricating oil is provided in the free space on a surface of the inner raceway and on a surface of the outer raceway, and a volume of the lubricating oil is less than 5% of a volume of the free space.

### CROSS-REFERENCE

This application claims priority to Chinese patent application no. 202311746783.3 filed on Dec. 18, 2024, the contents of which are fully incorporated herein by reference.

### TECHNOLOGICAL FIELD

The present disclosure is directed to a bearing, and more specifically, to a bearing with low friction torque.

### BACKGROUND

Some equipment that uses bearings requires bearings to have low friction torque when the bearings are running. For example, in a lithium battery film winding machine, if the friction torque of a bearing is large when the bearing is running, the film may have an uneven thickness or the film may even break. Therefore, it is desirable to provide a bearing with low friction torque when it is running.

### SUMMARY

A bearing includes an inner ring having an inner raceway, an outer ring having an outer raceway, rolling elements located between the inner raceway and the outer raceway, a cage for holding the rolling elements, and a seal. There is lubricating oil in a free space inside the bearing, and the lubricating oil is located on a surface of the inner raceway and on a surface of the outer raceway, and a volume of the lubricating oil accounts for less than 5% of a volume of the free space inside the bearing. The free space inside the bearing is space of the bearing inner space, excluding the rolling elements and the cage, and the bearing inner space is space defined by the inner ring, the outer ring and the seal.

According to this solution, by adopting liquid lubricating oil as the lubricant, and by controlling the ratio of the volume of the lubricating oil to the volume of the free space inside the bearing to be less than a certain specific value, the friction torque to which the bearing is subjected during rotation is significantly reduced.

In some solutions, the oil film thickness of the lubricating oil attached (applied) to the inner raceway and/or to the outer raceway can be less than 0.06 mm. Preferably, the oil film thickness can be between 0.01 mm and 0.05 mm.

In some solutions, the volume of the lubricating oil can account for less than 3% of the free space inside the bearing; preferably less than 2% of the free space inside the bearing.

In some solutions, a relative groove curvature Ri of the inner raceway satisfies 0.52≤Ri≤0.58, and/or a relative groove curvature Re of the outer raceway satisfies 0.53≤Re≤0.58.

According to this solution, for a bearing with a smaller diameter of rolling elements, by having an inner raceway and/or an outer raceway with a larger relative groove curvature, the friction between the rolling elements and the inner ring and/or the outer ring is reduced, thus significantly reducing the friction torque to which the bearing is subjected during rotation, and bringing unexpected improvement to the overall performance of the bearing.

In some solutions, a diameter Dr of the rolling elements satisfies Dr≤0.35*(H1-H2), where H1 is an outer diameter of the outer ring, and H2 is an inner diameter of the inner ring.

In some solutions, the viscosity of the lubricating oil is less than 25 cSt at a temperature of 40° C. Preferably, the viscosity of the lubricating oil is less than 20 cSt at the temperature of 40° C. More preferably, the viscosity of the lubricating oil is less than 15 cSt at the temperature of 40° C.

According to this solution, the use of lubricating oil with relatively low viscosity is helpful to reduce the friction between the rolling elements and the inner ring and/or the outer ring, thus reducing the friction torque to which the bearing is subjected during rotation.

In some solutions, a seal is arranged at an axial end of the bearing. The seal is fixed to one of the outer ring or the inner ring, and a gap is provided between the seal and the other of the outer ring or the inner ring. Preferably, the gap has a width extending in a radial direction of the bearing, and the width L2 is between 0.1 mm and 0.2 mm. Preferably, the gap has a length extending in an axial direction of the bearing, and the length L1 is between 0.1 mm and 2 mm.

According to this solution, by adopting non-contact sealing, the friction between the seal and the outer ring or the inner ring is reduced, thus further reducing the friction torque subjected to by the bearing during rotation.

According to a second aspect of the present disclosure, a method for attaching lubricating oil to a bearing is provided. The method includes immersing the bearing in the lubricating oil, the bearing including an inner ring with an inner raceway, an outer ring with an outer raceway, rolling elements located between the inner raceway and the outer raceway, a cage for holding the rolling elements, and a seal. The method further includes performing a centrifugal drying operation on the bearing to obtain a bearing for which the volume of the lubricating oil in a free space inside the bearing accounts for less than 5% of the volume of the free space inside the bearing. The lubricating oil is at least attached to the surface of the inner raceway and the surface of the outer raceway, the free space inside the bearing is space of the bearing inner space not occupied by the rolling elements and the cage, and the bearing inner space is space defined by the inner ring, the outer ring and the seal.

According to a third aspect of the present disclosure, a winding cylinder is provided, the winding cylinder including a shaft, the bearing according to the first aspect of the present disclosure provided on the shaft, and a rotatable cylinder provided on the bearing.

### BRIEF DESCRIPTION OF THE DRAWINGS

FIG. 1 is a sectional perspective view of a bearing according to an embodiment of the present disclosure.

FIG. 2 is a sectional view of part of a bearing according to an embodiment of the present disclosure.

FIG. 3 depicts a relationship between groove curvature and rolling element diameter according to an embodiment of the present disclosure.

FIG. 4 is a sectional view of a portion of a seal for a bearing according to an embodiment of the present disclosure.

FIG. 5 is a flowchart of a method for attaching (applying) lubricating oil to a bearing according to an embodiment of the present disclosure.

### DETAILED DESCRIPTION

In order to make the purpose, solutions and advantages of the technical scheme of the present disclosure clearer, technical solutions of some embodiments of the present disclosure will be described hereafter clearly and completely with the accompanying drawings of some specific embodiments of the present disclosure. Unless otherwise specified, the terms used herein have the ordinary meaning in the art. In the drawings, the same reference numerals represent the same parts.

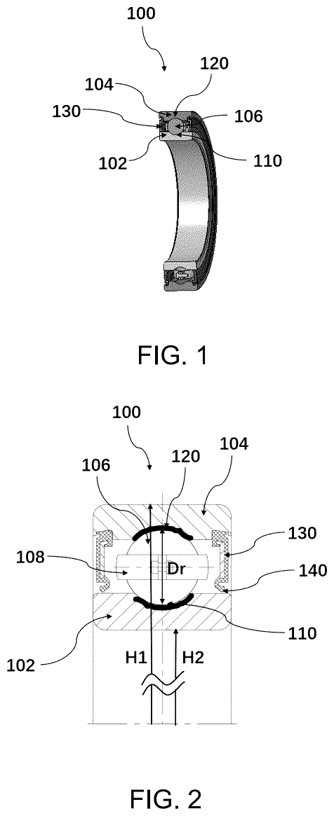

FIGS. 1 and 2 show schematic views of a bearing 100 according to some embodiments of the present disclosure. The bearing 100 includes an inner ring 102, an outer ring 104, rolling elements 106, a cage 108 and a seal 130. The inner ring 102 and the outer ring 104 can rotate concentrically with respect to each other, and the inner ring 102 has an inner raceway 110 and the outer ring 104 has an outer raceway 120 with the rolling elements 106 interposed between the inner raceway 110 and the outer raceway 120.

Different from the traditional lubricating method of applying lubricating grease in the bearing 100, according to the present disclosure, lubricating oil is used to coat surfaces inside the bearing 100 instead of lubricating grease, especially to coat the inner raceway 110 and/or the outer raceway 120 where the rolling elements 106 contact the bearing 100, so as to achieve the lubricating effect. Because lubricating oil has a lower viscosity (for example, a viscosity less than 25 cSt at a temperature of 40° C.) than a lubricating grease, compared with the solution of applying lubricating grease, coating lubricating oil can reduce the friction between the rolling elements 106 and the inner raceway 110 and/or the outer raceway 120, thus reducing the friction torque to which the bearing 100 is subjected during rotation. Preferably, the viscosity of the lubricating oil at the temperature of 40° C. can be greater than 5 cSt. In particular, in cases of using lubricating oil instead of lubricating grease, combining the parameters of the ratio of the volume of the lubricating oil to the volume of the free space inside the bearing described below, the performance of the bearing, especially the friction performance, is unexpectedly improved. In some cases, the friction torque to which the bearing 100 is subjected during rotation is reduced by about 50% compared with the friction torque to which a conventional bearing is subjected during rotation.

In the bearing 100 of the present disclosure, the volume of the lubricating oil accounts for less than 5% of the free space inside the bearing. The free space inside the bearing is space of the bearing inner space other than the space occupied by the rolling elements 106 and the cage 108, and the bearing inner space is space defined by the inner ring 102, the outer ring 104 and the seal 130. Using less lubricating oil is helpful to further reduce the friction between the rolling elements 106 and the inner ring 102 and/or the outer ring 104, thus reducing the friction torque to which the bearing 100 is subjected during rotation. This solution is especially suitable for cases in which external load on the bearing 100 is not large, because the oil film is not easy to be destroyed by the external load due to its relatively small volume. In addition, the volume of the lubricating oil can also account for less than 3% of the free space inside the bearing, which is helpful to further reduce the friction between the rolling elements 106 and the inner ring 102 and/or the outer ring 104, thus further reducing the friction torque to which the bearing 100 is subjected during rotation.

Preferably, the volume of lubricating oil can account for more than 2% of the free space inside the bearing. If the proportion of the volume of lubricating oil in the free space inside the bearing is too small, the lubrication effect may be insufficient. Therefore, the proportion of the volume of lubricating oil in the free space inside the bearing is set to be larger than 2%, so as to achieve sufficient lubrication effect. For bearings in the existing art, the ratio of the volume of lubricating material to the volume of the free space inside the bearing is usually high, generally higher than 15%. On the other hand, according to the present disclosure, by designing a ratio of the volume of lubricating material of the bearing to the volume of the free space inside the bearing much lower than that in the existing art, the performance of the bearing, especially the friction performance, is unexpectedly improved. In some cases, the friction torque to which the bearing 100 is subjected during rotation is reduced by about 50% compared with the friction torque to which a conventional bearing is subjected during rotation.

Accordingly, an appropriate volume of the lubricating oil can also be obtained by designing appropriate oil film thickness of the lubricating oil. As shown in FIG. 2, the black thickened portion indicates the oil film, and the thickness formed in the radial direction of the bearing 100 is the oil film thickness. The relationship between the oil film thickness h and the oil film volume V is V=S*h, where S is the surface area where the oil film contacts the outer surface of the inner ring 102 and the inner surface of the outer ring 104. In the solution of the present disclosure, the oil film thickness can be less than 0.05 mm. The use of a thinner oil film is helpful to reduce the friction between the rolling elements 106 and the inner ring 102 and/or the outer ring 104, thereby reducing the friction torque subjected to by the bearing 100 during rotation. The oil film thickness can also be larger than 0.01 mm. If the oil film thickness is too thin, it may lead to insufficient lubrication effect. Therefore, the oil film thickness is set to be larger than 0.01 mm to achieve sufficient lubrication effect. It should be understood that the present disclosure is not intended to limit the specific value of the oil film thickness, and lubricating oil with any other suitable oil film thickness can be used.

In order to reduce the friction torque to which the bearing 100 is subjected during rotation, a relatively large relative groove curvature is provided for the inner raceway 110 and/or the outer raceway 120 of the bearing 100. The relative groove curvature can be defined as the raceway radius divided by the diameter of the rolling element 106. The raceway radius is the radius of a circle where the arc fitting the raceway is located, that is, the radius of curvature of the raceway. That is, the relative groove curvature indicates the curving degree of the inner raceway 110 and/or the outer raceway 120 relative to the rolling element 106, which is equal to the ratio of the radius of curvature of the inner raceway 110 and/or the outer raceway 120 to the diameter of the rolling element 106. According to the definition of the relative groove curvature, if the relative groove curvature is equal to 0.5, it means that the curving degree of the inner raceway 110 and/or the outer raceway 120 is the same as that of the rolling element 106. Obviously, in order to accommodate the rolling element 106 in the inner raceway 110 and/or the outer raceway 120, the relative groove curvature needs to be larger than 0.5.

In some embodiments, the relative groove curvature of the inner raceway 110 is larger than 0.52 and the relative groove curvature of the outer raceway 120 is larger than 0.53.

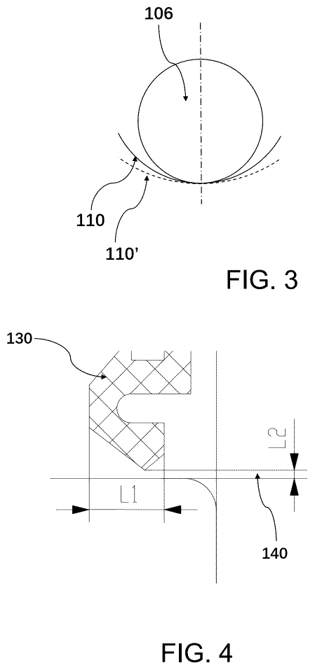

In FIG. 3, the relative groove curvature of the inner raceway 110 is smaller than that of the inner raceway 110′, from which it can be intuitively seen that the larger relative groove curvature of the inner raceway 110 means the larger gap between the rolling element 106 and the inner raceway 110. It should be understood that the relative groove curvature of the outer raceway 120 is similar to that of the inner raceway 110 and will not be described in detail here for the sake of brevity, and FIG. 3 is only schematic and not necessarily drawn to scale. In the bearing 100 of the present disclosure, the relative groove curvature of the inner raceway 110 is larger than 0.52 and/or the relative groove curvature of the outer raceway 120 is larger than 0.53. Properly designing a relatively large relative groove curvature of the inner raceway 110 and/or the outer raceway 120 makes the gap between the rolling element 106 and the inner raceway 110 and/or the outer raceway 120 relatively large, which can reduce the friction between the rolling element 106 and the inner raceway 110 and/or the outer raceway 120, so as to reduce the friction torque subjected to by the bearing 100 during rotation. In some embodiments, the relative groove curvature Ri of the inner raceway 110 satisfies 0.52≤Ri≤0.58, and/or the relative groove curvature Re of the outer raceway 120 satisfies 0.53≤Re≤0.58. In some embodiments, the relative groove curvature Ri of the inner raceway 110 satisfies 0.54≤Ri≤0.56, and/or the relative groove curvature Re of the outer raceway 120 satisfies 0.55≤Re≤0.58.

For bearings in the existing art, the relative groove curvature of the inner raceway 110 and/or the outer raceway 120 is not designed to be larger than 0.52, or even larger than 0.51. On the other hand, according to the present disclosure, by designing the relative groove curvature of the inner raceway and/or the outer raceway of the bearing significantly larger than that in the existing art, the performance of the bearing, especially the friction performance thereof, has been unexpectedly improved, especially for a bearing 100 with rolling elements of a relatively small diameter (for example, the diameter Dr of the rolling element 106 satisfies Dr≤0.35*(H1-H2), where H1 and H2 are the outer diameter and the inner diameter of the outer ring 104 respectively). The friction torque to which the bearing 100 is subjected during rotation is significantly lower than the friction torque to which a conventional bearing is subjected during rotation.

The present disclosure is particularly suitable for bearings 100 with a smaller diameter of rolling elements 106. Specifically, when the diameter Dr of the rolling elements 106 satisfies Dr≤0.35*(H1-H2), combined with technical features of the present disclosure such as the volume ratio of the lubricating oil in the free space of the bearing, the oil film thickness and the relative curvature of raceways, the friction torque to which the bearing 100 is subjected during rotation can be significantly reduced. Preferably, the inner diameter H2 of the inner ring satisfies 7 mm≤H2≤40 mm. More preferably, the inner diameter H2 of the inner ring satisfies 10 mm≤H2≤30 mm.

The demand for low friction limits the diameter of the rolling elements 106. If the diameter of the rolling elements 106 is too large relative to the overall size of the bearing 100, the rotation of the rolling elements 106 requires more external force, generating higher friction. In addition, if the rolling elements 106 are too large relative to the overall size of the bearing 100, the overall size spacing of the bearing 100 will be compressed, resulting in thinner wall thickness of the inner ring 102 and the outer ring 104, which increases the processing difficulty. On the other hand, if the diameter of the rolling elements 106 is too small relative to the overall size of the bearing 100, it will bring extremely high processing difficulty regarding the cage and the seal 130. Therefore, in some embodiments, the diameter Dr of the rolling elements 106 satisfies Dr≥0.2*(H1-H2). In some embodiments, the diameter Dr of the rolling elements 106 satisfies 0.25*(H1-H2)≤Dr≤0.32*(H1-H2).

Preferably, a seal 130 can also be provided at an axial end of the bearing 100. The seal 130 is fixed to one of the outer ring 104 or the inner ring 102, and a gap 140 of elongated shape is provided between the seal 130 and the other of the outer ring 104 or the inner ring 102. In other words, the seal 130 may be fixed to the outer ring 104 with a gap 140 between the seal 130 and the inner ring 102, or the seal 130 may be fixed to the inner ring 102 with a gap 140 between the seal 130 and the outer ring 104. As shown by FIG. 4, the gap 140 has a width L2 extending in the radial direction of the bearing 100 and a length L1 extending in the axial direction of the bearing 100. During the rotation of the bearing 100, this non-contact sealing of the seal 130 avoids friction torque on the bearing 100 generated by the contact of the seal 130 with the outer surface of the inner ring 102 or the inner surface of the outer ring 104, thus reducing the friction torque subjected to by the bearing 100 during rotation.

Preferably, the width L2 of the gap 140 between the seal 130 and the inner ring 102 may be between 0.1 mm and 0.2 mm. If the gap 140 is too wide, a good sealing effect cannot be obtained, while if the gap 140 is too narrow, the seal 130 may hinder the rotation of the bearing 100, thereby increasing the friction torque to which the bearing 100 is subjected during rotation. Therefore, setting the width L2 of the gap 140 in a suitable range is helpful to reduce the friction torque to which the bearing 100 is subjected during rotation, and to basically isolate the inner space of the bearing from the external environment. In addition, the length L1 of the gap 140 between the seal 130 and the inner ring 102 may be between 0.1 mm and 2 mm.

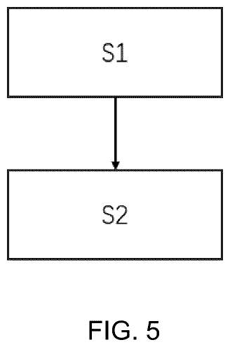

Refer to FIG. 5, the present disclosure further provides a method for attaching (applying) lubricating oil to a bearing (for example, the bearing 100), in which the lubricating oil is attached to at least the surface of the inner raceway 110 and the surface of the outer raceway 120. The free space inside the bearing is space of the bearing inner space not occupied by the rolling elements 106 and the cage, and the bearing inner space is space defined by the inner ring 102, the outer ring 104 and the seal 130. In step 1, first, the bearing 100 is immersed in the lubricating oil, and then in step 2, a centrifugal drying operation is performed on the bearing 100 to obtain a bearing for which the volume of the lubricating oil in a free space inside the bearing accounts for less than a specific value (for example, less than 5%) of the volume of the free space inside the bearing, In some embodiments, the volume of the lubricating oil of the bearing obtained accounts for less than 3% of the free space inside the bearing; preferably less than 2% of the free space inside the bearing. In some embodiments, the volume of the lubricating oil accounts for more than 0.5% of the free space inside the bearing.

In some embodiments, the viscosity of the lubricating oil is less than 25 cSt at a temperature of 40° C. Preferably, the viscosity of the lubricating oil is less than 20 cSt at the temperature of 40° C. More preferably, the viscosity of the lubricating oil is less than 15 cSt at the temperature of 40° C.

In some embodiments, through the above steps, the oil film thickness of the lubricating oil attached to the inner raceway and/or the outer raceway is less than 0.06 mm. Preferably, the oil film thickness is between 0.01 mm and 0.05 mm.

In some embodiments, the relative groove curvature Ri of the inner raceway satisfies 0.52≤Ri≤0.58, and/or the relative groove curvature Re of the outer raceway satisfies 0.53≤Re≤0.58. In some embodiments, the relative groove curvature Ri of the inner raceway satisfies 0.54≤Ri≤0.56, and/or the relative groove curvature Re of the outer raceway satisfies 0.55≤Re≤0.58.

In some embodiments, a diameter Dr of the rolling elements satisfies Dr≤0.35*(H1-H2), H1 being an outer diameter of the outer ring and H2 being an inner diameter of the inner ring. In some embodiments, the diameter Dr of the rolling elements satisfies Dr≥0.2*(H1-H2). Preferably, the diameter Dr of the rolling elements satisfies 0.25*(H1-H2)≤Dr≤0.32*(H1-H2). In some embodiments, the inner diameter H2 of the inner ring satisfies 7 mm K H2≤40 mm. Preferably, the inner diameter H2 of the inner ring satisfies 10 mm K H2≤30 mm.

In some embodiments, a seal is arranged at an axial end of the bearing. The seal is fixed to one of the outer ring or the inner ring, and a gap is provided between the seal and the other of the outer ring or the inner ring. Preferably, the gap has a width L2 extending in a radial direction of the bearing, and the width L2 is between 0.1 mm and 0.2 mm. Preferably, the gap has a length L1 extending in an axial direction of the bearing, and the length L1 is between 0.1 mm and 2 mm.

The bearing 100 of the present disclosure can be used for a winding cylinder, the winding cylinder including a shaft, a bearing 100 provided on the shaft, and a rotatable cylinder provided on the bearing 100.

A number of exemplary embodiments of the present disclosure have been described in detail herein with reference to some preferred embodiments. However, those skilled in the art can understand that various variations and modifications can be made to the above specific embodiments without departing from the concept of the present disclosure, and various technical features and structures proposed in the present disclosure can be combined without exceeding the protection scope of the present disclosure, which is determined by the appended claims.

What is claimed is:

1. A bearing comprising:
an inner ring having an inner raceway;
an outer ring having an outer raceway;
rolling elements located between the inner raceway and the outer raceway;
a cage for holding the rolling elements; and
a seal;
wherein a bearing inner space is defined by the inner ring, the outer ring and the seal;
wherein a free space is a portion of the bearing inner space not occupied by the rolling elements and the cage,
wherein lubricating oil is provided in the free space on a surface of the inner raceway and on a surface of the outer raceway, and
wherein a volume of the lubricating oil is less than 5% of a volume of the free space.

2. The bearing according to claim 1,
wherein an oil film thickness of the lubricating oil on the inner raceway and/or on the outer raceway is less than 0.06 mm.

3. The bearing according to claim 1,
wherein an oil film thickness of the lubricating oil on the inner raceway and/or on the outer raceway is between 0.01 mm and 0.05 mm.

4. The bearing according to claim 1,
wherein a volume of the lubricating oil is less than 3% of the free space.

5. The bearing according to claim 1,
wherein a volume of the lubricating oil is less than 2% of the free space.

6. The bearing according to claim 4,
wherein the volume of the lubricating oil is more than 0.5% of the free space.

7. The bearing according to claim 1,
wherein a relative groove curvature Ri of the inner raceway satisfies 0.52≤Ri≤0.58 and/or a relative groove curvature Re of the outer raceway satisfies 0.53≤Re≤0.58.

8. The bearing according to claim 1,
wherein a diameter Dr of the rolling elements satisfies Dr≤0.35*(H1-H2), where H1 is an outer diameter of the outer ring, and H2 is an inner diameter of the inner ring;

7. The bearing according to claim 1,
wherein a viscosity of the lubricating oil is less than 25 cSt at a temperature of 40° C.

8. The bearing according to claim 1,
wherein a viscosity of the lubricating oil is less than 20 cSt at a temperature of 40° C.

9. The bearing according to claim 1,
wherein a viscosity of the lubricating oil is less than 15 cSt at a temperature of 40° C.

10. The bearing according to claim 1,
the seal is provided at an axial end of the bearing and is fixed to a first one of the outer ring and the inner ring, and a gap is provided between the seal and the other one of the outer ring or the inner ring.

11. The bearing according to claim 10,
wherein the gap has a radial width between 0.1 mm and 0.2 mm and an axial length between 0.1 mm and 2 mm.

12. A method for applying lubricating oil to a bearing, comprising:
immersing the bearing in the lubricating oil, the bearing including an inner ring with an inner raceway, an outer ring with an outer raceway, rolling elements located between the inner raceway and the outer raceway, a cage for holding the rolling elements, and a seal;
performing a centrifugal drying operation for the bearing to obtain a bearing for which the volume of the lubricating oil in a free space inside the bearing accounts for less than 5% of the volume of the free space inside the bearing,
wherein the lubricating oil is at least attached to the surface of the inner raceway and the surface of the outer raceway,
wherein the free space inside the bearing is space of the bearing inner space not occupied by the rolling elements and the cage, and
wherein the bearing inner space is a space defined by the inner ring, the outer ring and the seal.

13. A winding cylinder comprising:
a shaft;
the bearing according to claim 1 arranged on the shaft; and
a rotatable cylinder arranged on the bearing.
